(19) United States
(12) Patent Application Publication
(10) Pub. No.: US 2007/0214968 A1
(43) Pub. Date: Sep. 20, 2007

(54) Fry basket

(75) Inventors: Eric W. Larson, Pecatonica, IL (US); Edward T. Eaton, Eola, IL (US); Eugene L. DiMonte, Aurora, IL (US)

Correspondence Address: John R. Hoffman, P.O. Box 191, 616 W. 13th Street, Jasper, IN, 47547, US

(73) Assignee: Prince Castle Inc.

(21) Appl. No.: 11/384,893

(22) Filed: Mar. 20, 2006

(51) Int. Cl. A47J 37/12

(52) U.S. Cl. 99/403

(57) ABSTRACT

A fry basket includes an open top basket frame having a plurality of upright side walls defining a frying space therewithin. One side of the basket frame is positionable on a support structure above a food receiving station. At least one perforate trap door is movably mounted on the basket frame for movement between a closed position closing a drop opening at the bottom of the frame and an open position to allow cooked food to drop through the opening onto the food receiving station. Actuating means are provided for automatically moving the trap door from its closed to its open position simply in response to moving the basket frame relative to the support structure.

### FIELD OF THE INVENTION

This invention generally relates to the art of food preparation and, particularly, to a basket for holding food products during cooking, such as a wire basket for holding food products in a deep frying apparatus, and for depositing the fried products at a food receiving station.

### BACKGROUND OF THE INVENTION

Various types of containers or baskets are used for holding food products during cooking. For instance, wire or other perforate baskets are used for holding various types of food products, such as french fries, fried chicken or other meat products and the like in a deep frying apparatus. Typically, the baskets are loaded with the bulk food products and are lowered into a reservoir of hot frying oil. In preparing french fried potatoes, for instance, a typical wire basket is of an open-top structure, rectangular in configuration, and includes upright side walls about a bottom wall. One or more handles may be provided for manually or automatically lowering the wire basket and food products into the hot frying oil to cook the products by immersion and frying in the hot oil. After a required amount of cooking time, the basket then is removed from the hot oil and the excess oil is drained from the cooked products. The basket then is moved, typically by hand, to a food receiving station whereat the products, such as french fries, are dumped onto a salting or serving tray or platform.

The above sequence of operations, particularly the dumping operation, often involve workers being over zealous and causing damage to the cooked or fried food products. For instance, french fries may be broken which creates an undesirable presentation. Although trap doors have been proposed for such cooking or frying baskets to make the dumping operation less abusive and more consistent, such mechanisms typically are complicated and can even involve an operator having to use both hands to operate the basket. The present invention is directed to solving these problems and providing a fry basket which is exceedingly simple to operate and consistent in operation and function.

### SUMMARY OF THE INVENTION

An object, therefore, of the invention is to provide a new and improved fry basket of the character described for frying food products such as french fries.

In the exemplary embodiment of the invention, the fry basket includes an open top basket frame having a plurality of upright side walls defining a frying space therewithin. One side of the basket frame is positionable on a support structure above a food receiving station. At least one perforate trap door is movably mounted on the basket frame for movement between a closed position closing a drop opening at the bottom of the frame and an open position to allow cooked food to drop through the opening onto the food receiving station. Actuating means are provided for automatically moving the trap door from its closed position to its open position simply in response to moving the basket frame relative to the support structure.

In one embodiment of the invention, latch means are provided for holding the trap door in its closed position. The latch means is releasable in response to biasing the latch means against the support structure as the basket frame is moved relative to the support structure. As disclosed herein, the latch means comprises a spring loaded latch member operatively engageable with the trap door. The spring loaded latch member is mounted on the basket frame at the one side thereof adjacent the support structure. The latch member is biasingly engageable with the support structure to release the trap door in response to biasing the latch member against the support structure.

According to one aspect of the invention, the actuating means include the engaging means in the form of a hook on the basket frame to hang the fry basket on the support structure. The actuating means is rigid with the hook, and the basket frame is movable downwardly relative to the hook and the actuating means and, in turn, relative to the support structure for automatically moving the trap door from its closed position to its open position. As disclosed herein, the actuating means comprise at least one actuating arm projecting from the hook and engageable with the trap door for automatically moving the trap door in response to moving the basket frame.

According to other aspects of the invention, the hook is located at one end of the basket frame, and a manually graspable handle is located at an opposite end of the basket frame to facilitate manual movement of the basket frame relative to the support structure. As disclosed herein, two trap doors are pivotally mounted to the basket frame and are movable in opposite directions to opposite sides of the basket frame to dump the food products out of the drop opening and into the food receiving station.

Other objects, features and advantages of the invention will be apparent from the following detailed description taken in connection with the accompanying drawings.

### BRIEF DESCRIPTION OF THE DRAWINGS

The features of this invention which are believed to be novel are set forth with particularity in the appended claims. The invention, together with its objects and the advantages thereof, may be best understood by reference to the following description taken in conjunction with the accompanying drawings, in which like reference numerals identify like elements in the figures and in which:

FIG. 1A is a front perspective view of a fry basket according to a first embodiment of the invention, with the trap doors in their closed positions;

FIG. 1B is a front elevational view of the fry basket of FIG. 1A;

FIG. 1C is a rear perspective view of the fry basket hanging from a support structure;

FIG. 1D is a side elevational view of the depiction in FIG. 1C;

FIG. 1E is a top plan view of the fry basket as in FIGS. 1C and 1D;

FIGS. 2A-2E are views similar to that of FIGS. 1A-1E, respectively, but showing the trap doors partially open;

FIGS. 3A-3E are views similar to that of FIGS. 1A-1E, respectively, but showing the trap doors in their fully opened positions;

FIG. 4A is a perspective view looking at the front end of the fry basket as in FIG. 1A;

FIG. 4B is an enlarged depiction of the area encircled in FIG. 4A;

FIG. 4C is a vertical section taken generally along line 4C-4C in FIG. 4A;

FIGS. 5A and 5B are views similar to that of FIGS. 4A and 4B, but showing the trap doors in an unlatched condition;

FIG. 6A is a vertical section through the fry basket in a front-to-rear direction, showing the basket hanging from the support structure and with the trap doors in their open position;

FIG. 6B is an enlarged depiction of the area encircled in FIG. 6A, showing the latch means in its released condition;

FIG. 7 is a view of a fry basket according to a second embodiment of the invention, with the basket being positioned into a support structure, and with the trap doors in their closed positions;

FIG. 8 is a view similar to that of FIG. 7, with the fry basket moved downwardly relative to the support structure to open the trap doors;

FIG. 9 is an enlarged rear elevational view of the fry basket in FIG. 7, showing the trap doors in their closed positions; and

FIG. 10 is a view similar to that of FIG. 9, but showing the trap doors in their open positions.

### DETAILED DESCRIPTION OF THE PREFERRED EMBODIMENTS

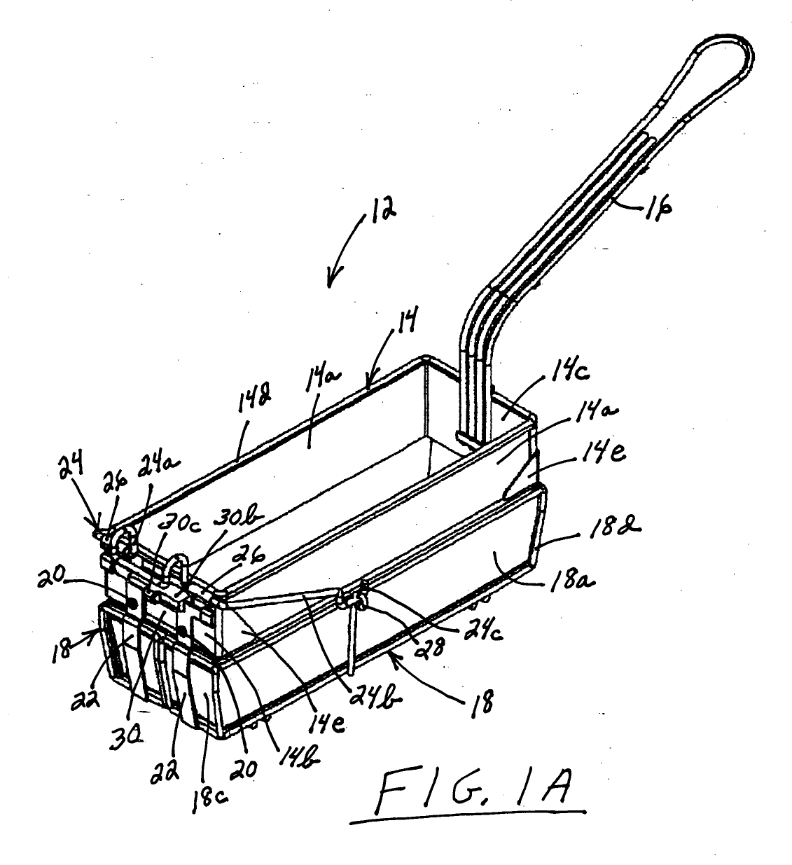

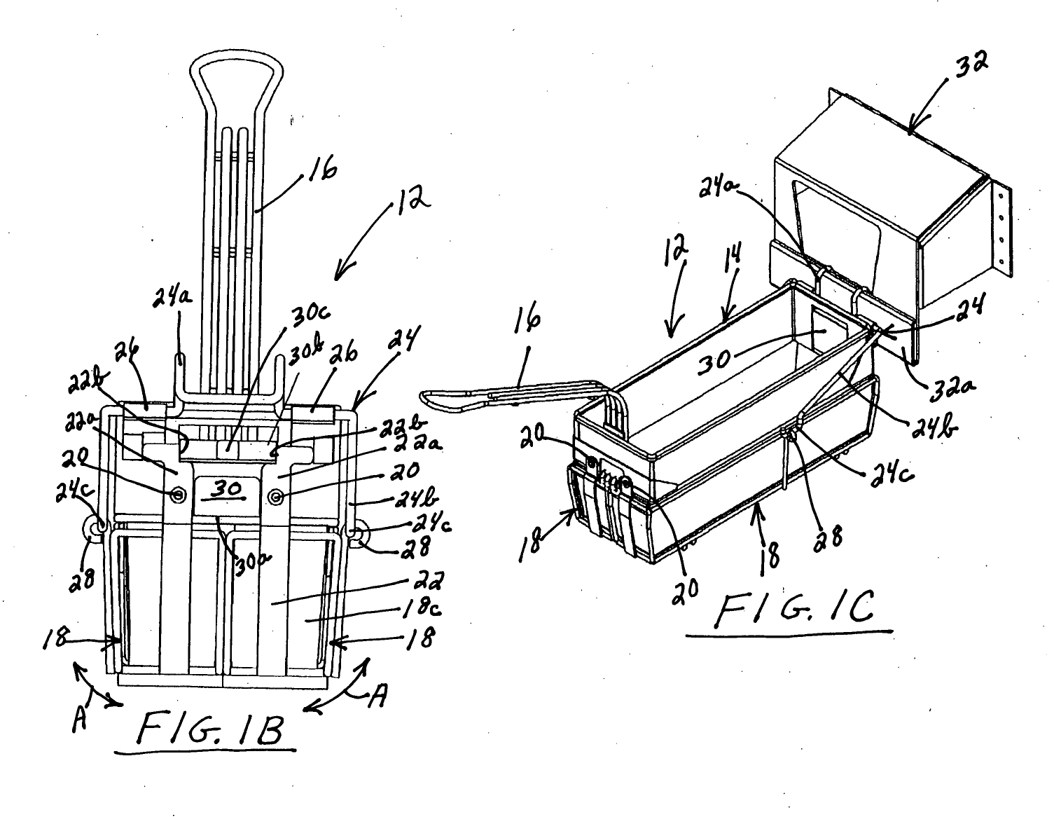

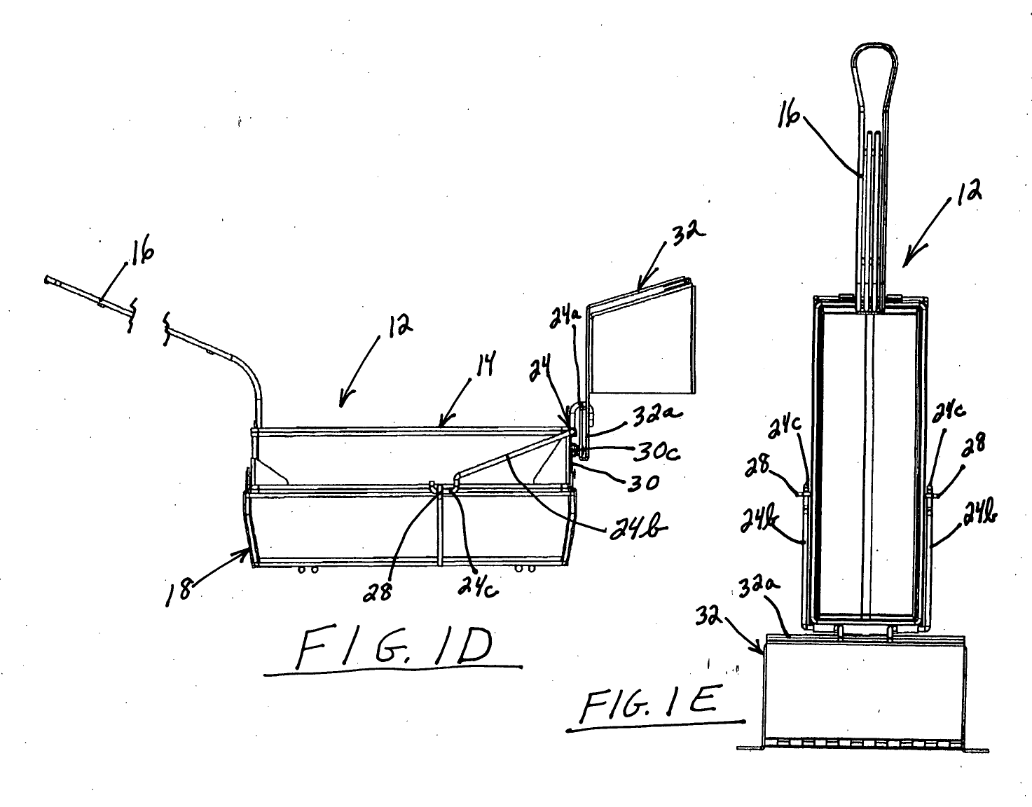

Referring to the drawings in greater detail, and first to FIGS. 1A and 1B, a fry basket, generally designated 12, is shown according to a first embodiment of the invention. The basket is provided for frying food products, such as french fries, prepared by immersion and frying in a reservoir of hot cooking oil. The fry basket includes an open top basket frame, generally designated 14, which generally includes a plurality of upright side walls defining a frying space therebetween. Specifically, basket frame 14 includes a pair of elongated side walls 14a, a front side wall 14b and a rear side wall 14c. The basket frame includes a rigid, rectangular, rod framing support 14d about the top thereof and which defines the open top of the fry basket, along with other supporting brackets 14e, all of which combine to support the planar bodies of the side walls which may be of a wire mesh or other perforate material. The side walls define a bottom drop opening 15. A manually graspable handle 16 is fixed to basket frame 14 at the rear side wall 14c thereof and projects upwardly and outwardly of the fry basket for grasping by an operator.

A pair of trap doors, generally designated 18, are movably, pivotally mounted on basket frame 14, at pivot points 20. The trap doors are generally L-shaped in vertical cross section and include side walls 18a, bottom walls 18b (shown hereinafter) and end walls 18c. Like basket frame 14, the trap doors include wire framing supports 18d with the planar bodies of the trap door walls being of a wire mesh or otherwise perforate material. A latch arm 22 is fixed to the front of each trap door 18 and may be a metal strap, for instance. The latch arms form the pivot points 20 for the trap doors and extend above the pivot points to define latching portions 22a of the trap arms as seen in FIG. 1B. A latch shoulder 22b is formed at the inside of each latching portion 22a of each latch arm 22, again as best seen in FIG. 1B. The trap doors can pivot relative to the basket frame in the direction of double-headed arrows “A” (FIG. 1B).

A combination engaging and actuating means or member, generally designated 24, is swingably, movably mounted on basket frame 14 for hanging the fry basket on a support structure and for opening trap doors 18. Specifically, the engaging and actuating member 24 is a rigid wire form structure which is rotatably or swingably mounted on basket frame 14 by means of a pair of journals 26 which are fixed to the front of the rigid wire framing support 14d. The rigid wire form structure 24 has a hook 24a for hanging fry basket 12 on a support structure as will be seen hereinafter. The rigid wire form structure includes a pair of actuating arms 24b which project rearwardly and downwardly at an angle as best seen in FIG. 1A. Each actuating arm terminates in a hook 24c which is interengaged in a loop 28 which is fixed to and projects outwardly from a respective one of the trap doors.

Generally, latch means are provided for holding trap doors 18 in closed positions as shown in FIGS. 1A and 1B. Specifically, the latch means include a spring loaded latch member 30 which is fixed at its base 30a to front wall 14b of basket frame 14, but the latch member otherwise is movable relative to the front wall. In the preferred embodiment, latch member 30a is a planar leaf spring of spring metal material. An enlarged latch bar 30b spans the top edge of the latch member which, effectively, is a free swinging edge of the leaf spring. Latch bar 30b is enlarged and includes a forwardly projecting release boss 36c which effectively releases the latch means upon biasing the release boss against the support structure as described hereinafter. Suffice it to say at this point, FIG. 1B shows that opposite ends of latch bar 30b are interengaged with latch shoulders 22b of latch arms 22 which, in turn, are fixed to the trap doors, whereby the trap doors are latched in their closed positions, as shown.

FIGS. 1C and 1D show fry basket 12 hung onto an appropriate support structure, generally designated 32. The support structure can take a variety of configurations, but the support structure typically would be located above a food receiving station, such as a salting and serving station which would receive french fries from the fry basket. In order to be operable with fry basket 12, as described above, support structure 32 includes a supporting rail 32a which has a thickness for seating into the hanging hook 24a of the rigid wire form structure 24 of the fry basket and, thereby, hangingly support the fry basket on the support structure. Supporting rail 32a must be wide enough for engaging the release boss 32c of latch member 30 as seen in FIG. 1D. FIG. 1D also is also a good depiction of how one of the actuating arms 24b extends angularly downwardly from hook 24a, with the hook 24c at the distal end of the actuating arm interengaged within loop 28 of the trap door at that side of the fry basket, keeping in mind that the trap doors are latched in their closed positions of FIGS. 1A-1E.

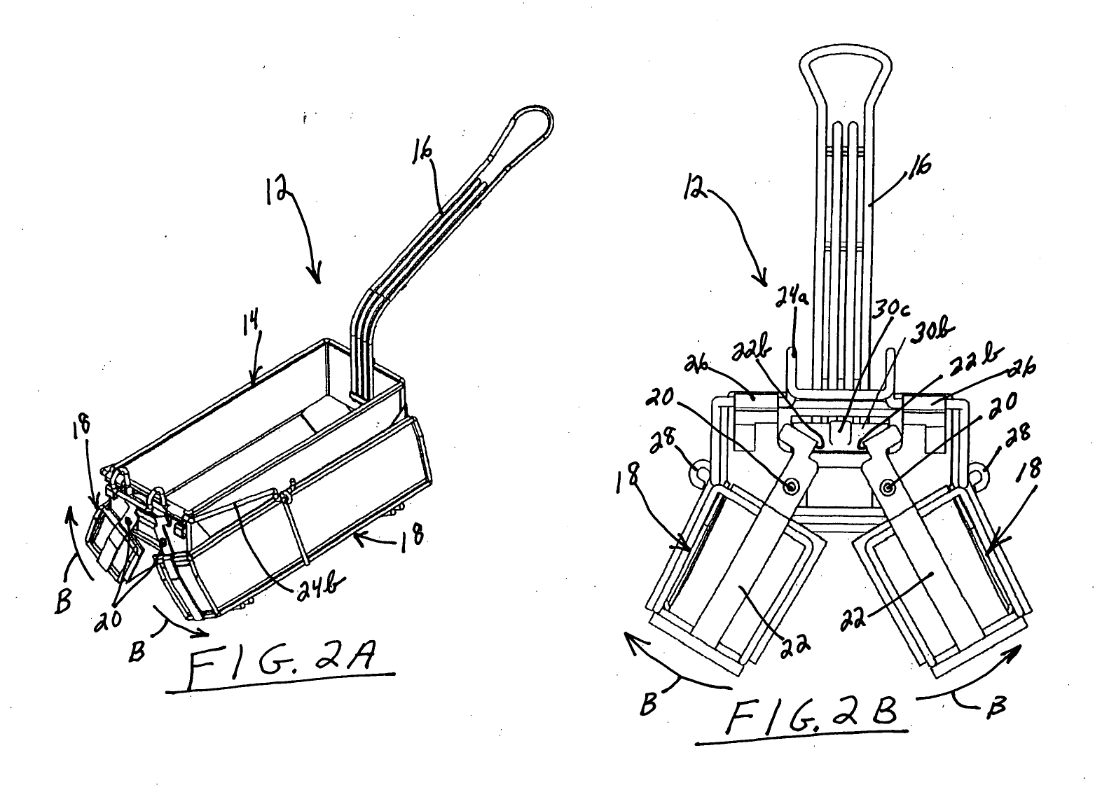

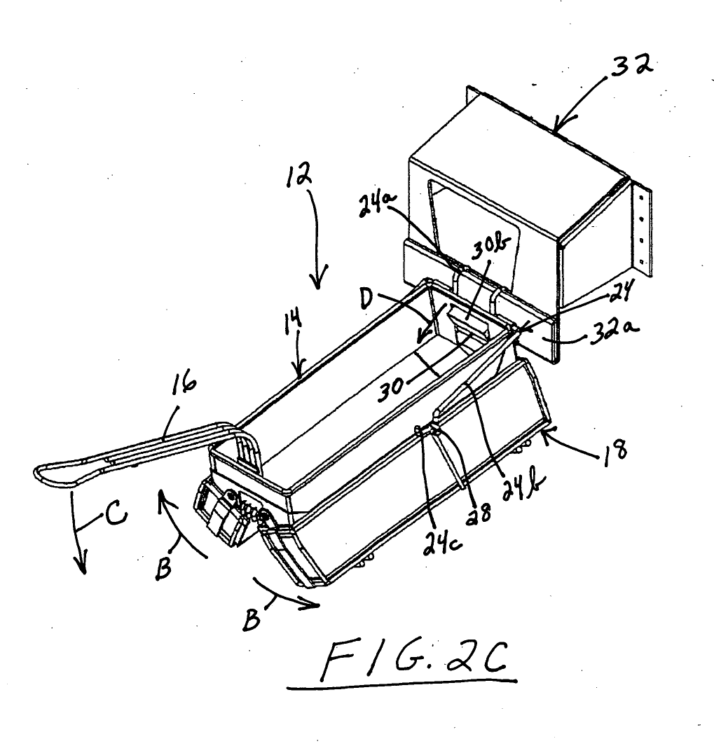

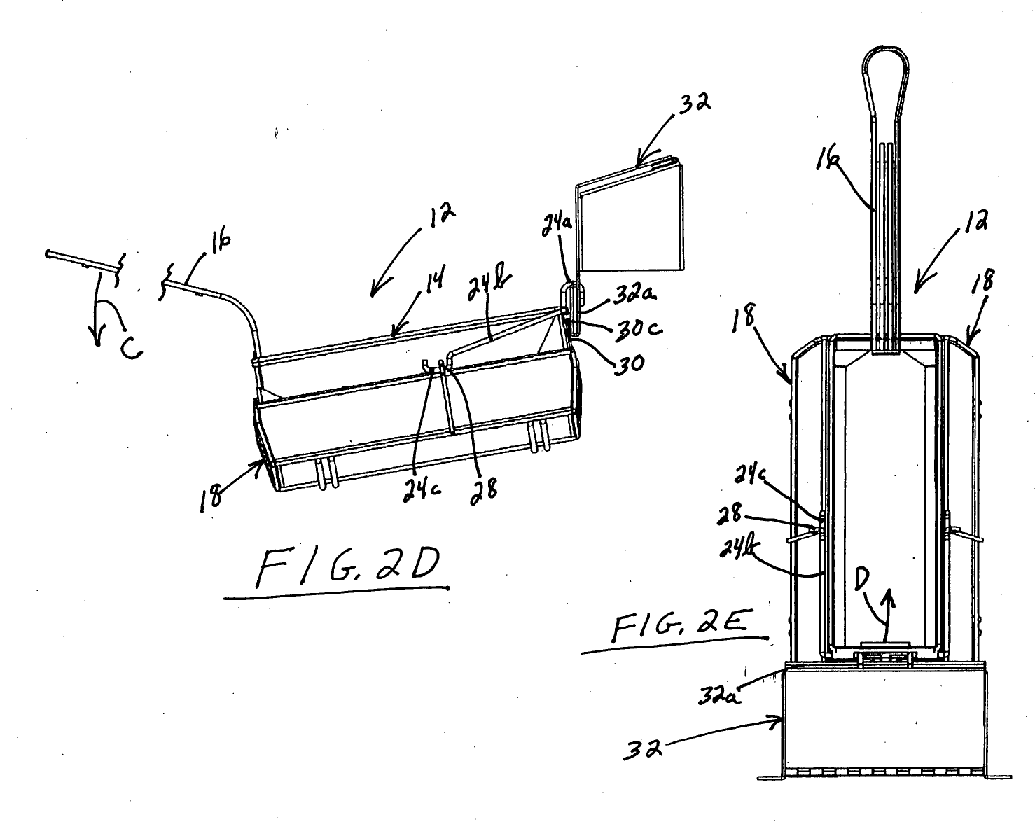

Although FIGS. 2A and 2B do not show fry basket 12 supported on support structure 32, all of FIGS. 2A-2E show the fry basket in a condition wherein trap doors 18 have been unlatched and are partially opened in the direction of arrows “B” (FIG. 2B). After hook 24a is hung onto support rail 32a as seen in FIGS. 2C and 2D, an operator pushes down on handle 16 in the direction of arrows “C” as shown in FIGS. 2C and 2D. This pivots basket frame 14 downwardly with the handle. As a result, release boss 30c is pushed or biased against supporting rail 32a as seen in FIG. 2D which, in turn, causes the spring-loaded latch member or leaf spring 30 to move inwardly in the direction of arrow “D” in FIG. 2C. As this occurs, the opposite ends of latch bar 30b (FIG. 2B) move out of latching engagement with latch shoulders 22b on latch arms 22 which are fixed to trap doors 18. This unlatches the latch doors. Simultaneously, actuating arms 24b (which are rigid with hook 24a) remain stationary, along with the hooks 24c at the distal ends of the actuating arms. As handle 16 and basket frame 14 move downwardly in the direction of arrow “C”, actuating arms 24b are effective to “lift” trap doors 18 relative to the basket frame of the fry basket. Actually, the trap doors are not lifted upwardly, but the trap doors hang onto the fixed hooks 24c of the actuating arms 24b and, as the basket frame moves downwardly, the trap doors effectively pivot about pivot points 20 upwardly relative to the basket frame in the direction of arrows “B” (FIG. 2B).

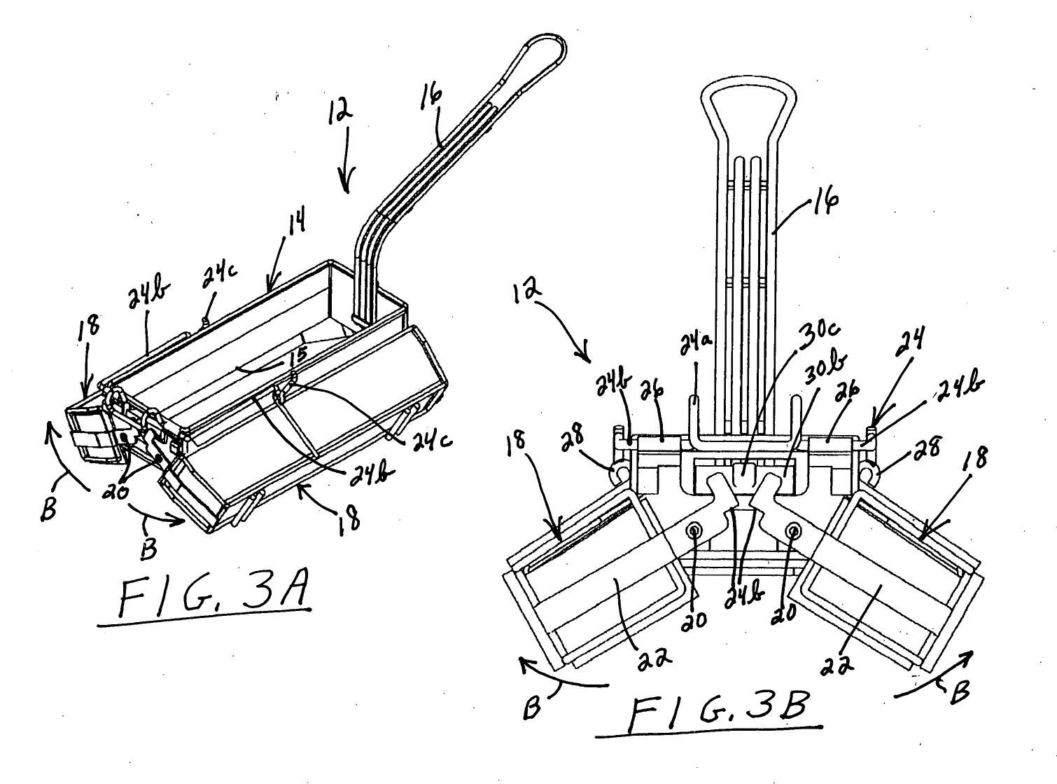

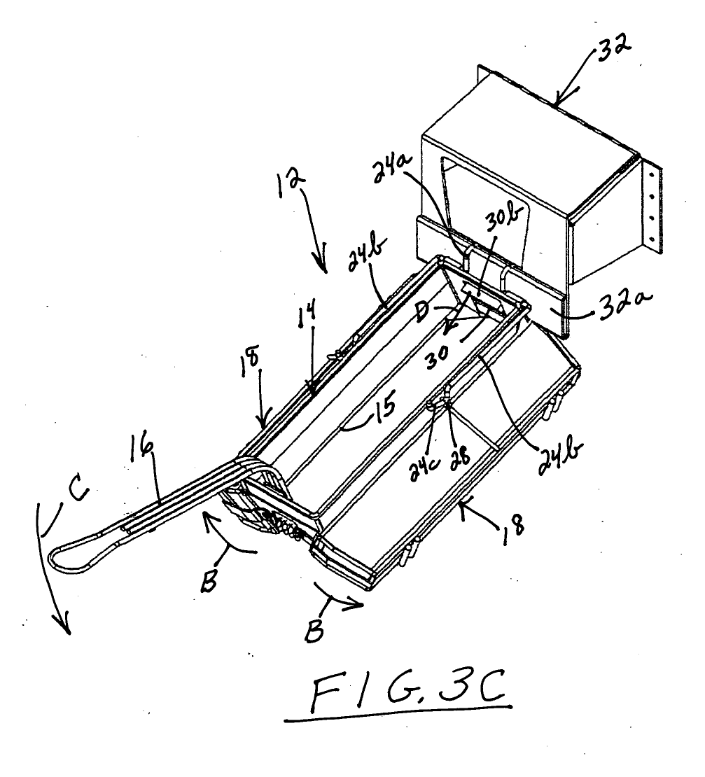

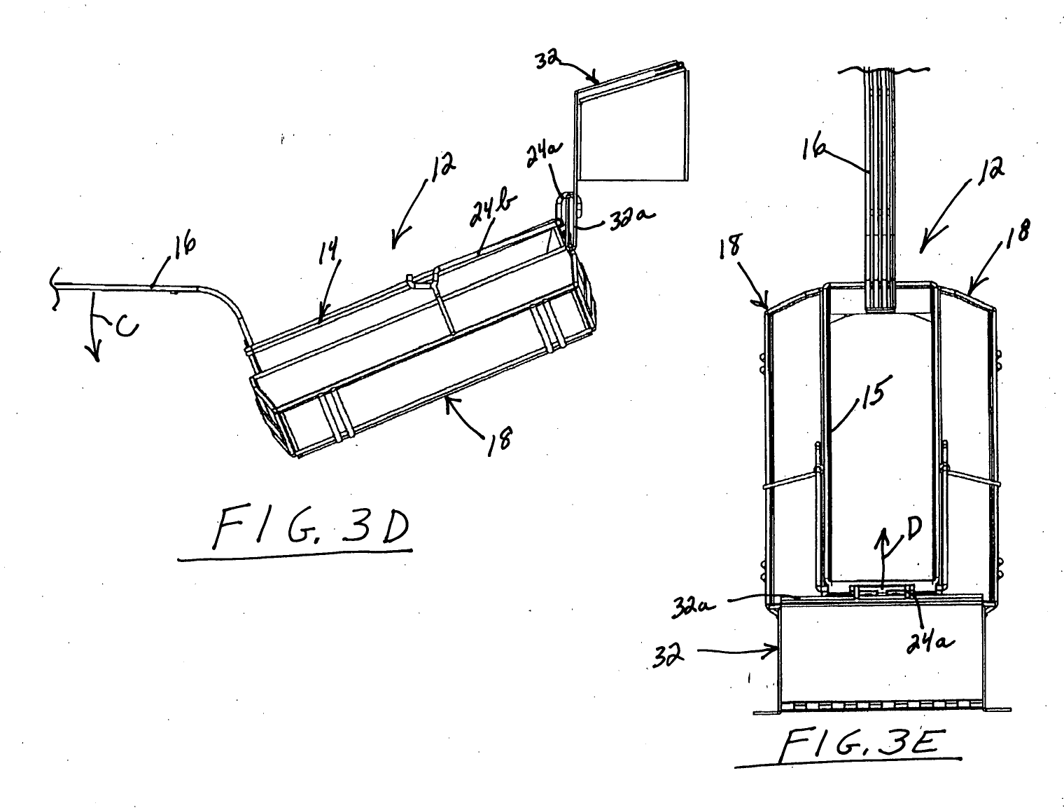

FIGS. 3A-3E show handle 12 and basket frame 14 pivoted downwardly about hook 24a further in the direction of arrow “C”. This movement is effective to pivot trap doors 18 completely to their open positions, as shown. The trap doors now are completely outside drop opening 15 at the bottom of the basket frame, whereupon the food products (french fries) can drop out of the fry basket and into a subjacent food receiving station.

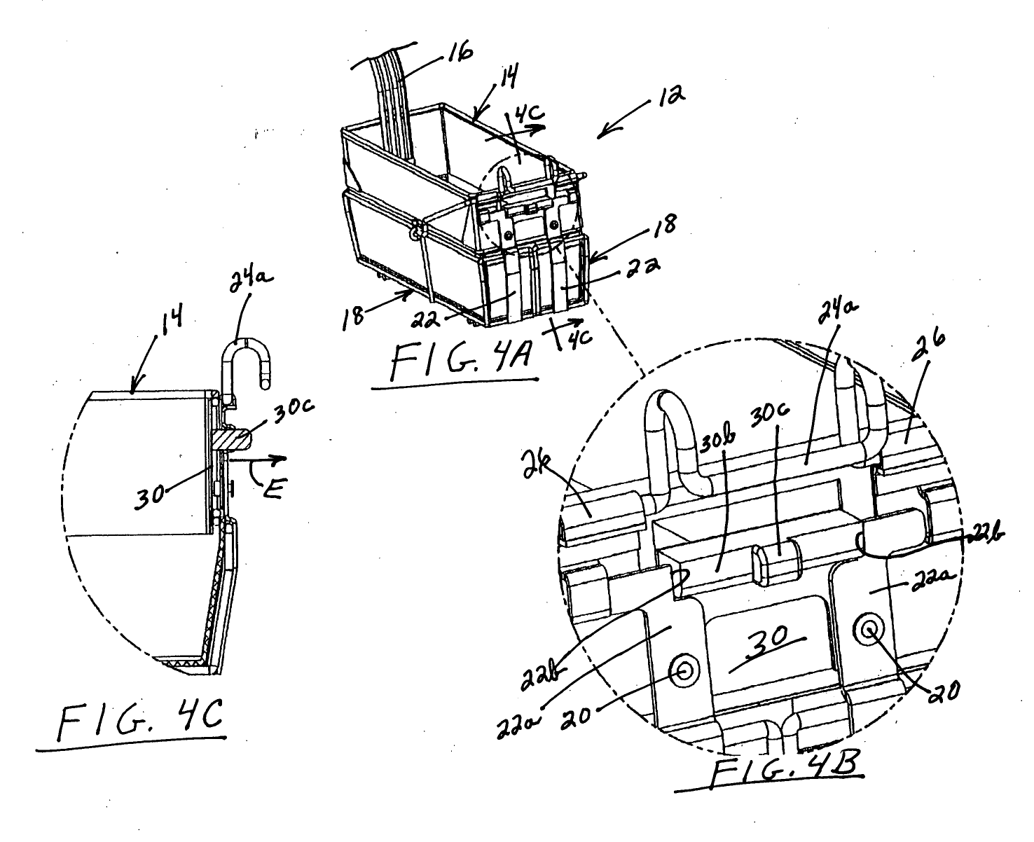

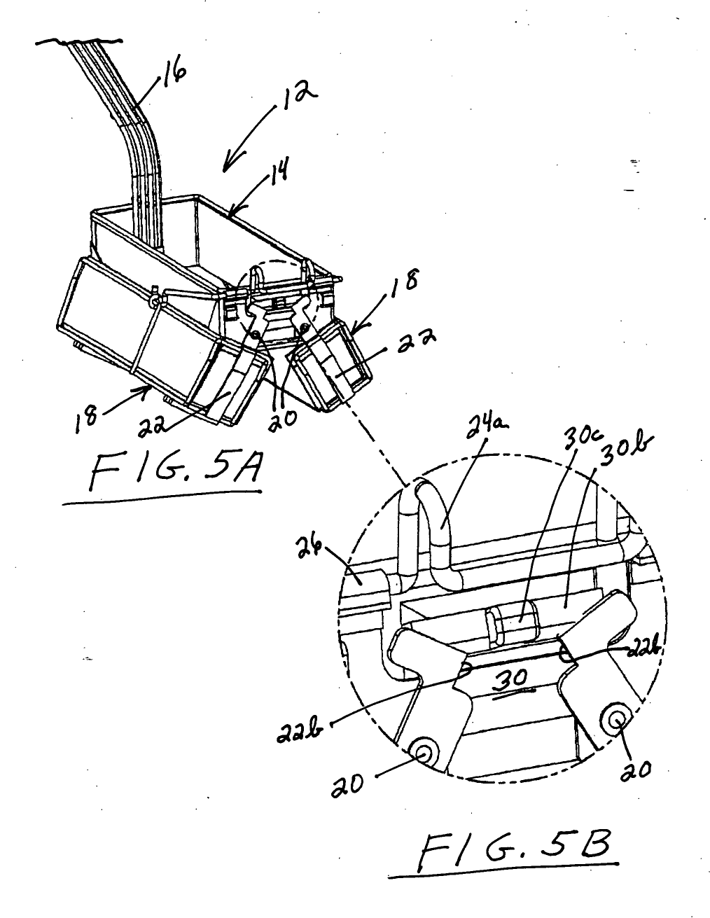

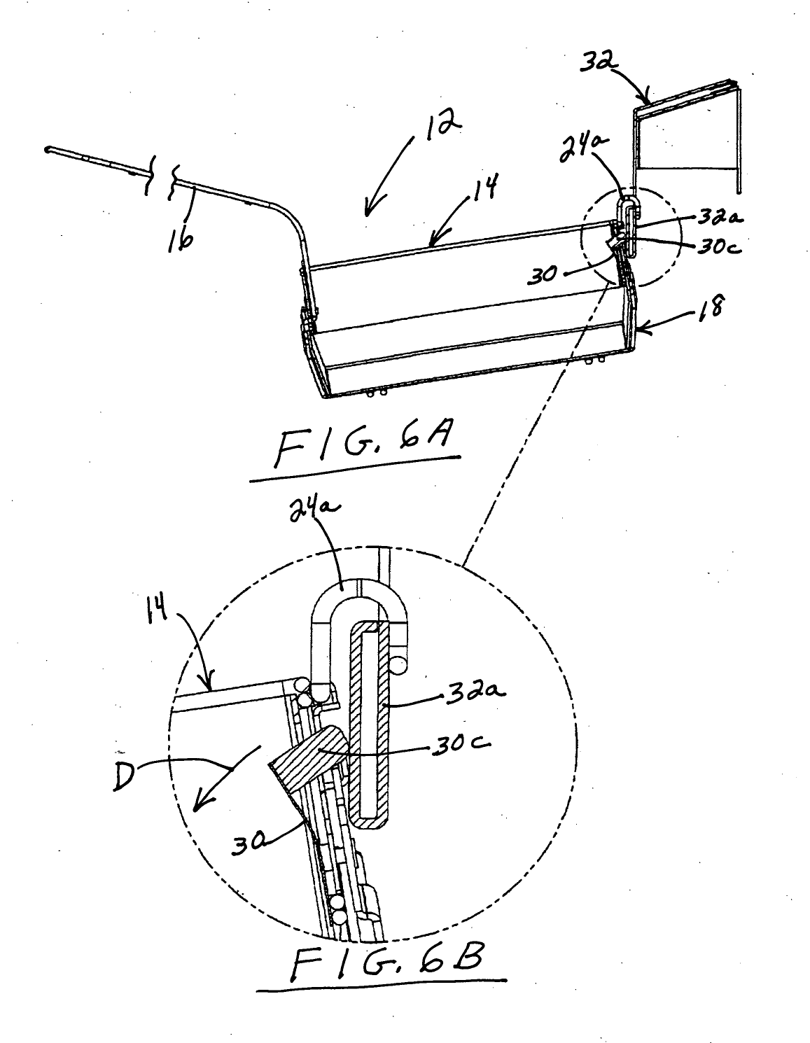

FIGS. 4A-4C are enlarged depictions to further show how trap doors 18 are held in their closed positions as seen in FIG. 4A. As seen in FIG. 4B, latch shoulders 22b at the upper ends of latch arms 22 (which are fixed to the trap doors) are in latching engagement with opposite ends of latch bar 30b of the spring loaded latch member or leaf spring 30. When the fry basket is removed from the supporting rail 32a of support structure 32, leaf spring 30 tends to move in the direction of arrow “E” (FIG. 4C) to its latched condition. When the trap doors are returned to their closed position, the leaf spring and latch bar 30b tend to “snap” into latching condition with latch shoulders 22b, as release boss 30c projects forwardly of basket frame 14 in position for biasingly engaging supporting rail 32a when the fry basket again is hung onto the supporting rail as seen in FIGS. 6A and 6B. Again, as handle 16 and basket frame 14 are pivoted downwardly in the direction of arrow “C” (FIG. 6A), release boss 30c biasingly engages supporting rail 32a as seen in FIG. 6B, causing leaf spring 30 to move inwardly in the direction of arrow “D”, causing latch bar 30b (FIG. 5B) to move out of engagement with latch shoulders 22b on the fry baskets as seen in FIGS. 5A and 5B.

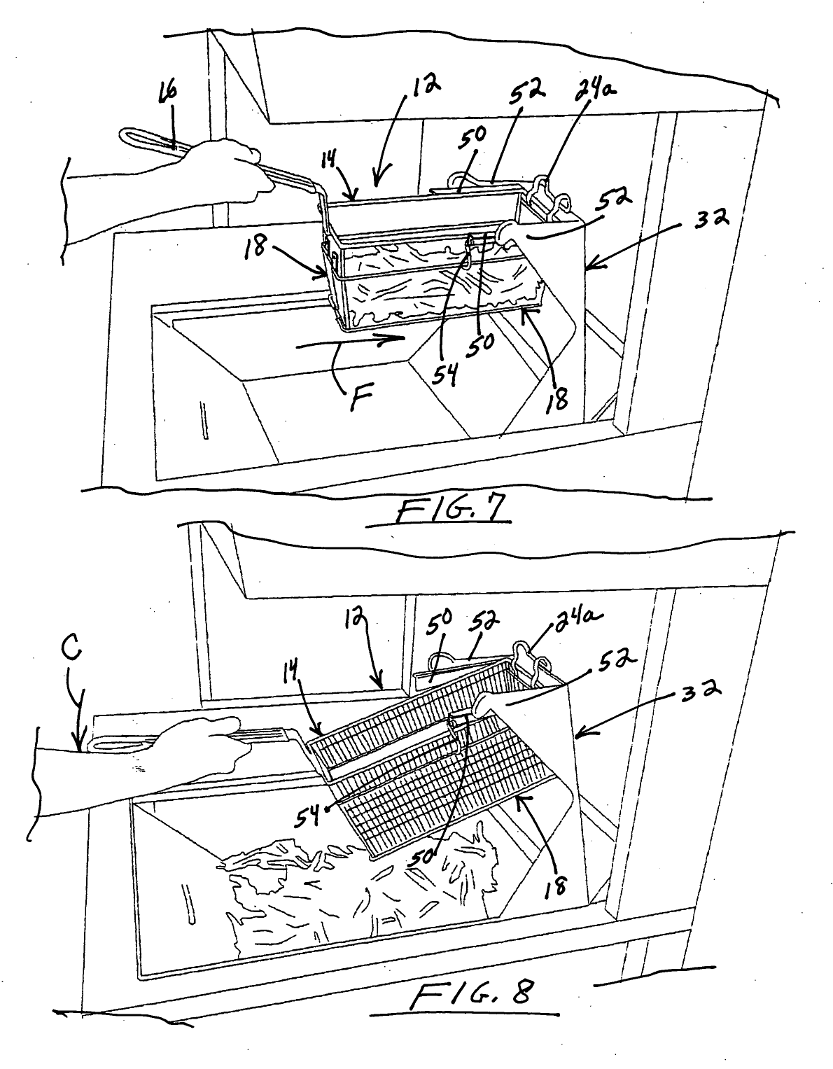

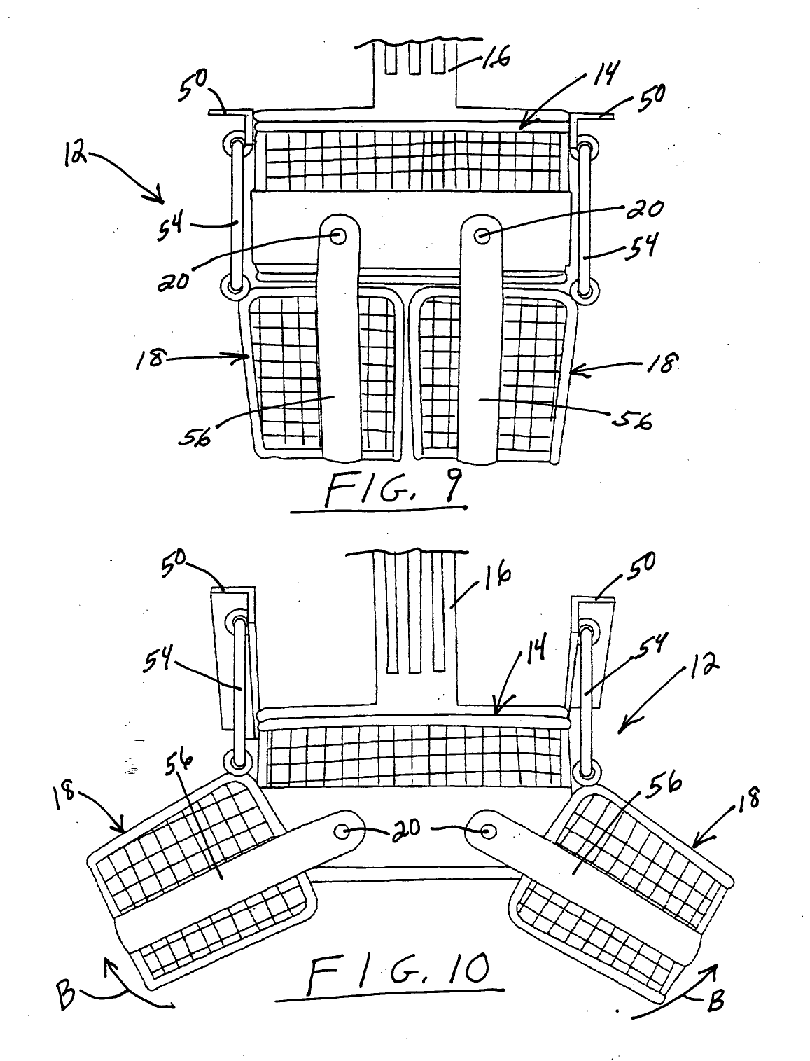

FIGS. 7-10 show a second embodiment of the invention. Like reference numerals have been applied in FIGS. 7-10 to designate like components described above in relation to the first embodiment. Specifically, a fry basket 12 again includes a basket frame 14 pivotally mounted to a hanging hook 24a at one end and having a handle 16 at an opposite end. A pair of trap doors 18 again are pivotally mounted to the basket frame at pivot points 20 (FIGS. 9 and 10). The trap doors again are pivotally movable from closed positions shown in FIGS. 7 and 9 to open positions shown in FIGS. 8 and 10.

In the second embodiment, a pair of actuating rails 50 are fixed to hook 24a, whereby the actuating rails remain fixed relative to a pair of support arms 52 of a support structure 32 when the fry basket is hung on the support structure. Generally horizontal grooves (not visible in the drawings) are formed on the insides of support arms 52 for receiving actuating rails 50 when the fry basket is moved against the support structure in the direction of arrow “F” (FIG. 7). A pair of hook-like members 54 are interengaged between actuating rails 50 and trap doors 18.

Still referring to FIGS. 7-10, when an operator pushes down on handle 16 and, in turn, basket frame 14 in the direction of arrow “C”, actuating rails 50 remain fixed and supported on support arms 52 of the support structure. With the hook-like members 54 interengaged between the actuating rails and the trap doors, the trap doors are pivoted upwardly in the direction of arrows “B” (FIG. 10) to open the trap doors and allow the food products (french fries) to drop out of the fry basket.

Although not visible in the drawings, a latch means as described above in relation to the first embodiment could be used in the second embodiment to hold the trap doors in their closed positions and to release the trap doors when the handle and the basket frame are pivoted downwardly as described above. On the other hand, a simple spring could be interconnected between pivot arms 56 as seen in FIG. 9, to bias the trap doors to their closed positions when the fry basket is pulled out from between support arms 52 of support structure 32.

It will be understood that the invention may be embodied in other specific forms without departing from the spirit or central characteristics thereof. The present examples and embodiments, therefore, are to be considered in all respects as illustrative and not restrictive, and the invention is not to be limited to the details given herein.

1. A fry basket for frying food products, comprising:
an open top basket frame including a plurality of upright side walls defining a frying space therewithin, one side of the basket frame being positionable on a support structure above a food receiving station;
at least one perforate trap door movably mounted on the basket frame for movement between a closed position closing a drop opening at the bottom of the basket frame and an open position to allow cooked food to drop through the opening onto the food receiving station;
latch means for holding the trap door in its closed position, the latch means being releasably in response to biasing the latch means against said support structure; and
actuating means for automatically moving the trap door from its closed position to its open position in response to moving the basket frame relative to said support structure.

2. The fry basket of claim 1 wherein said latch means comprise a spring loaded latch member operatively engageable with said trap door.

3. The fry basket of claim 2 wherein said spring loaded latch member is mounted on the basket frame at said one side thereof and is biasingly engageable with the support structure to release the trap door in response to biasing the latch member against the support structure.

4. The fry basket of claim 1, including a hook on the basket frame to hang the fry basket on the support structure with the latch means adjacent the support structure.

5. The fry basket of claim 1 wherein said actuating means include engaging means for positioning the basket frame on the support structure, the basket frame being movable relative to the engaging means and, in turn, relative to the support structure for automatically moving the trap door from its closed position to its open position.

6. The fry basket of claim 5 wherein said engaging means comprises a hook on the basket frame to hang the fry basket on the support structure, said actuating means being rigid with the hook, and the basket frame being movable downwardly relative to the hook and the actuating means and, in turn, relative to the support structure.

7. The fry basket of claim 6 wherein said actuating means comprise at least one actuating arm projecting from the hook and engageable with the trap door for automatically moving the trap door in response to moving the basket frame.

8. The fry basket of claim 6 wherein said hook is located at one end of the basket frame, and including a manually graspable handle at an opposite end of the basket frame to facilitate manual movement of the basket frame relative to the support structure.

9. A fry basket for frying food products, comprising:
an open top basket frame including a plurality of upright side walls defining a frying space therewithin, one side of the basket frame being positionable on a support structure above a food receiving station;
at least one perforate trap door movably mounted on the basket frame for movement between a closed position closing a drop opening at the bottom of the basket frame and an open position to allow cooked food to drop through the opening onto the food receiving station; and
latch means for holding the trap door in its closed position, the latch means being releasably in response to biasing the latch means against said support structure.

10. The fry basket of claim 9 wherein said latch means comprise a spring loaded latch member operatively engageable with said trap door.

11. The fry basket of claim 10 wherein said spring loaded latch member is mounted on the basket frame at said one side thereof and is biasingly engageable with the support structure to release the trap door in response to biasing the latch member against the support structure.

12. The fry basket of claim 9, including a hook on the basket frame to hang the fry basket on the support structure with the latch means adjacent the support structure.

13. The fry basket of claim 12, including a hook on the basket frame at one end thereof to hang the fry basket on the support structure, the hook being operatively associated with the trap doors to open the trap doors when the basket frame is pivoted downwardly about the hook relative to the support structure.

14. A fry basket for frying food products, comprising:
an open top basket frame including a plurality of upright side walls defining a frying space therewithin, one side of the basket frame being positionable on a support structure above a food receiving station;
at least one perforate trap door movably mounted on the basket frame for movement between a closed position closing a drop opening at the bottom of the basket frame and an open position to allow cooked food to drop through the opening onto the food receiving station; and
actuating means for automatically moving the trap door from its closed position to its open position in response to moving the basket frame relative to said support structure.

15. The fry basket of claim 14 wherein said actuating means include engaging means for positioning the basket frame on the support structure, the basket frame being movable relative to the engaging means and, in turn, relative to the support structure for automatically moving the trap door from its closed position to its open position.

16. The fry basket of claim 15 wherein said engaging means comprises a hook on the basket frame to hang the fry basket on the support structure, said actuating means being rigid with the hook, and the basket frame being movable downwardly relative to the hook and the actuating means and, in turn, relative to the support structure.

17. The fry basket of claim 16 wherein said actuating means comprise at least one actuating arm projecting from the hook and engageable with the trap door for automatically moving the trap door in response to moving the basket frame.

18. The fry basket of claim 16 wherein said hook is located at one end of the basket frame, and including a manually graspable handle at an opposite end of the basket frame to facilitate manual movement of the basket frame relative to the support structure.

19. A fry basket for frying food products, comprising:
a hanger bracket for hanging the basket on a support structure, the bracket having an actuating portion;
an open top basket frame movably mounted on the hanger bracket and including a plurality of upright side walls defining a frying space therebetween;
at least one perforate trap door movably mounted on the basket frame for movement between a closed position closing a drop opening at the bottom of the basket frame and an open position to allow cooked food to drop through the opening onto the food receiving station; and
said trap door being connected to the actuating portion of the hanger bracket whereby the actuating portion is effective to move the trap door to its open position automatically in response to moving the basket frame relative to the hanger bracket.

20. The fry basket of claim 19 wherein said basket frame is pivotally mounted to the hanger bracket whereby the basket frame can be pivoted downwardly toward a food receiving station to open the trap door.

21. The fry basket of claim 20 wherein said hanger bracket is mounted at one end of the basket frame, and including a manually graspable handle at an opposite end of the basket frame to facilitate pivoting the basket frame downwardly relative to the hanger bracket and the support structure.

22. The fry basket of claim 20, including means pivotally mounting the trap door to the basket frame for pivotally moving the trap door between its closed and open positions.

23. The fry basket of claim 19, including latch means for holding the trap door in its closed position, the latch means being releasably in response to biasing the latch means against said support structure.

24. The fry basket of claim 23 wherein said latch means comprise a spring loaded latch member operatively engageable with said trap door.
